(19) United States
(12) Patent Application Publication
(10) Pub. No.: US 2008/0028263 A1
(43) Pub. Date: Jan. 31, 2008

(54) Apparatus and method for protection of JTAG scan chains in a microprocessor

(76) Inventor: Noemi Fernandez, Houston, TX (US)

Correspondence Address: TEXAS INSTRUMENTS INCORPORATED, P O BOX 655474, M/S 3999, DALLAS, TX, 75265, US

(21) Appl. No.: 11/643,107

(22) Filed: Dec. 21, 2006

Related U.S. Application Data
(60) Provisional application No. 60/833,231, filed on Jul. 25, 2006.

(51) Int. Cl. G06F 11/36

(52) U.S. Cl. 714/30

(57) ABSTRACT

In an integrated circuit processing unit having an emulation unit fabricated therewith, signal group protection apparatus is provided for prohibiting unauthorized access by the test and debug procedures to selected signal groups stored in the memory units. The integrated circuit includes a memory unit storing the addresses of the protected data. The stored addresses of the protected data are compared with the addresses of data being accessed by the test and debug procedure. When the addresses are the same, the protected data is prevented from being forwarded to the emulation unit. An UNLOCK signal is provided to permit access to the normally protected data.

### BACKGROUND OF THE INVENTION

1. Field of the Invention

This invention relates generally to integrated circuit processing units having test and debug facilities such as JTAG capabilities, and more particularly, to the security of test and debug procedures with respect to unauthorized access.

2. Background of the Invention

As the dimensions of the circuit board elements have decreased in size, the number of elements and the complexity of the circuits has continued to increase. Even test apparatus is now included on an integrated circuit board.

Referring to FIG. 1, an integrated circuit data processing unit 10, according to the prior art, is shown. The processor core 11 executes instructions and performs most of the complex processing activity. The data, instruction, and control signal groups needed for the operation of the processor core 11 are stored in various memory devices such as random access memory (RAM) units 14, read only memory (ROM) units 15, and Flash memory units 16. The signal groups are exchanged between the memory units 14, 15, and 16 and the processor core 11 over the CPU bus 17. The exchange of signals groups between the memory units 14, 15, and 16 and the processing core 11 is performed by a direct memory access unit 12, the direct memory access unit 12 relieving the processor core 11 of some of the routine tasks in the movement of signal groups. A parallel mode test unit 19, coupled to the CPU bus 17, typically provides a testing facility for the processing unit 10 during fabrication. Both the direct management unit 12 and the parallel mode testing unit 19 are coupled to the processor core 11 by the CPU bus 17. The test and debug of particular interest with respect to the present invention involve an external host processing unit 5, the host processing unit 5 controlling the test and debug procedures executed on the processing unit 10. The host processing unit 5 is coupled through test port 6 to emulation unit 12. The emulation unit 12 provides an interface between the host processing unit 5 and the apparatus of processor core. By way of example, the emulation unit 12 has a group of circuit elements coupled to the CPU bus 17. In this manner, the emulation unit 12 can apply test and debug signals to the CPU bus 17 and can monitor signals applied to the CPU bus 17 as well as other portions of the processing unit 10 through JTAG scan chains.

The JTAG test and debug apparatus is currently one of the leading methods for the verification of the operation microprocessors and digital signal processing devices. However, as indicated in FIG. 1, the security of stored data can be compromised by monitoring the CPU bus 17 during the retrieval of selected data groups from memory unit 14, 15, and 16 during test procedures. By monitoring the data on the CPU bus scan chains in response to preselected instructions, signal groups stored in the memory units 14, 15, and 16 can be monitored even though those signal groups are to be protected from unauthorized access.

A need has therefore been felt for apparatus and an associated method having the feature that selected signal groups will be protected from being retrieved during test and debug procedures. It would be a further feature of the apparatus and associated method to protect selected areas in the memories associated with a processor core from being retrieved during test and debug procedures. It is a more particular feature of the apparatus and associated method to prevent JTAG test and debug procedures from accessing specified signal groups in memory units associated with a core processor. A still more particular feature of the apparatus and associated method is to protect selected data in memory units associated with the processing core.

### SUMMARY OF THE INVENTION

The aforementioned and other features are accomplished, according the present invention, by providing security apparatus that monitors the retrieval of data from the memory unit associated with the processor core by the test and debug procedure. When a test and debug procedure attempts to retrieve protected data, the security apparatus prevents the signals from being retrieved from the CPU bus. The data can be divided into secure data and non-secure data. A JTAG memory security module can determine the accessibility of the data to the test and debug process. The memory security module can respond to control signals from the JTAG security module generated in response to an attempt to access protected signal groups and can prevent protected data groups from being transmitted to the emulation unit. While all memory modules can be monitored, the Flash memory typically stores the most important signal groups.

Other features and advantages of present invention will be more clearly understood upon reading of the following description and the accompanying drawings and the claims.

### BRIEF DESCRIPTION OF THE DRAWINGS

FIG. 1 is block diagram of a data processing system according to the prior art capable of advantageously using the present invention.

FIG. 2 is block diagram of the data processing system of FIG. 1 with a memory security module included in the circuit according to the present invention.

FIG. 3 is a block diagram of the components in the memory security module that can be used to implement the invention.

### 1. DETAILED DESCRIPTION OF THE FIGURES

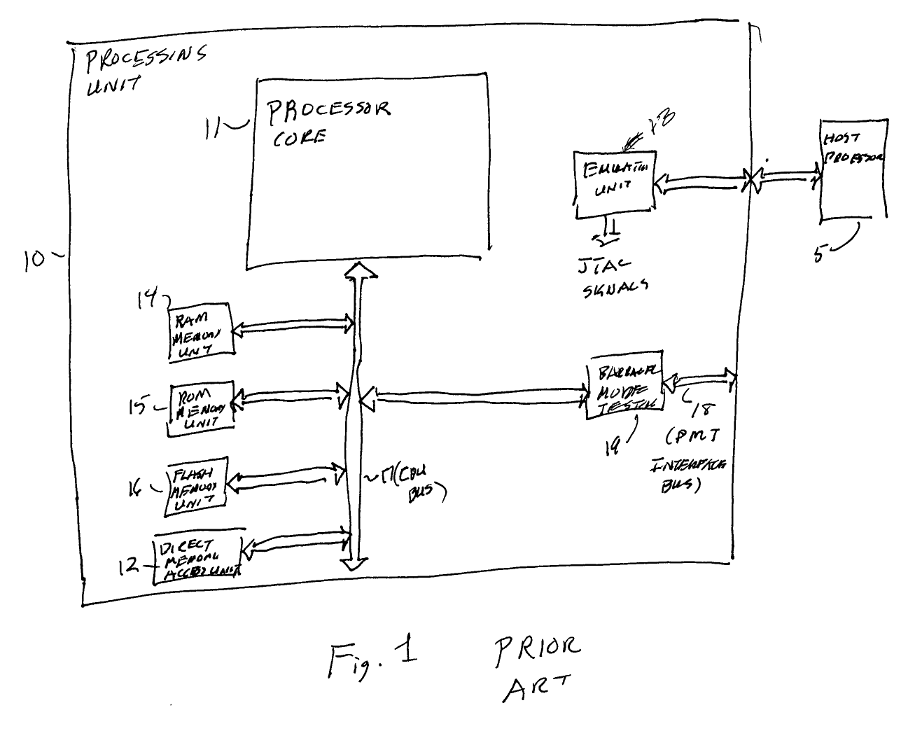

FIG. 1 has been discussed with respect to the related art.

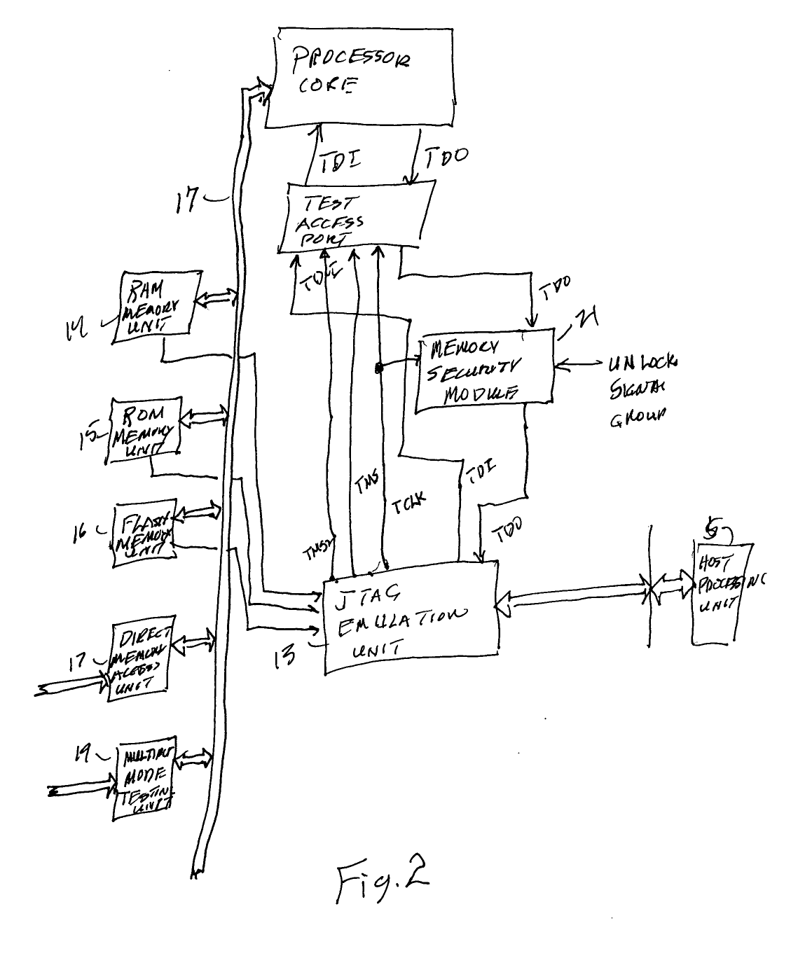

Referring to FIG. 2, a block diagram of an integrated circuit of FIG. 1 with the addition of the memory security module 21 according to the present invention is shown. Under control of the host processing unit 5, the JTAG emulation unit 13 for the JTAG test and debug procedure of the core processor 11 and associated circuits are shown. The JTAG emulation unit 13 generates a TMS (test mode select) signal, a TCK (test clock) signal, a TRST (test reset) signal (an optional signal) and a TDI (test data in) signal. The JTAG emulation unit 13 receives the TDO (test data out) signal which is forwarded to the host processing unit 5 for analysis. The TCK signal is applied to the memory security module 21 and to the test access unit 29. The TMS signal and the TDI signal are applied to the test access port 29. The TDI signal is applied from the test access port to the processor core. The TDO signal is generated in the core processor 11 as a result of the test and debug procedures and is applied to the test access port 29. The TDO signal is transmitted by the test access port and applied to the memory security module 21. The TDO signal is transmitted from the memory security module to the JTAG emulation unit. The memory security module receives signals from the RAM memory unit 14, the ROM memory unit, and the Flash memory unit 16.

An unlock data signal group can be applied to either the JTAG security module 22 or to the memory security module 21 by the user. This signal group provides the means for user to obtain protected signal groups that would otherwise be protected.

Referring once again to FIG. 2, a test access port (TAP) 25 is shown as providing an interface between the JTAG signals and the processor core 11. The TAP unit 25 provides a state-machine interface between the JTAG signal apparatus and selected processor cores. In particular, selected ARM processor cores can not interact directly with the JTAG signal format and must be provided with an interface unit to utilize the JTAG test and debug procedures.

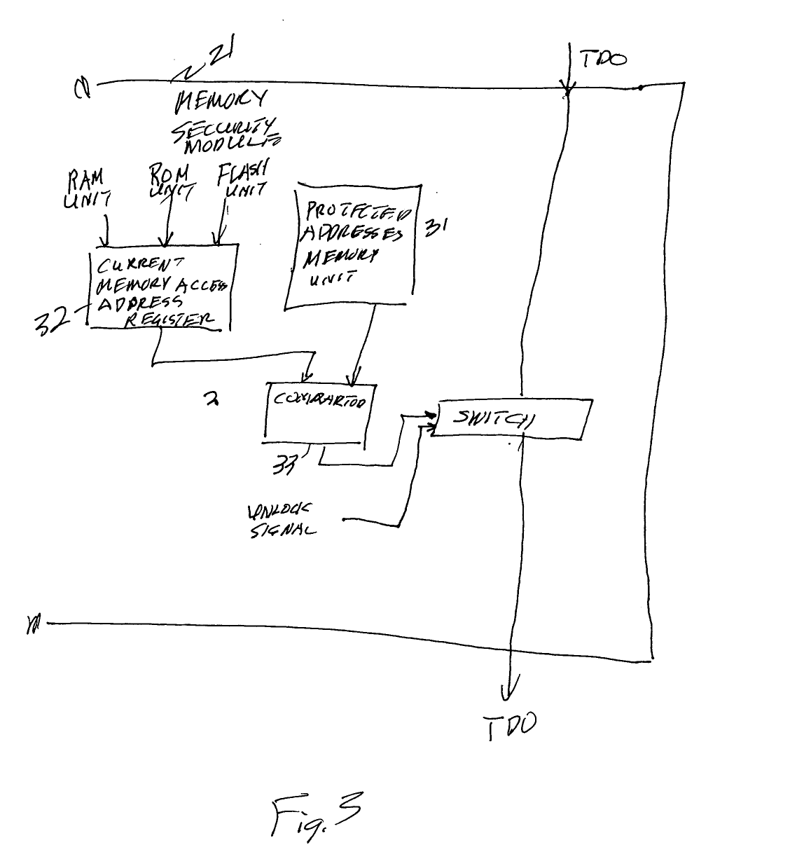

Referring to FIG. 3, the components of the memory security module 21 relevant to the present invention are shown. The protected address memory unit 31 stores the addresses of the locations in memory units 14, 15, and 16 that are to be protected from access by the test and debug procedures. The addresses stored in the protected address memory unit 31 can be stored during the initial testing of the circuit 10 or provision can be made for a user to store and/or update the protected addresses in the memory. A current memory access address register 32 receives from the memory units 14, 15, and 16 the memory addresses currently being accessed by the system. The memory address(es) stored in register 32 is compared with the protected addresses stored in the protected addresses memory unit 31 in comparator 33. Comparator 33 is enabled by an ENABLE signal generated as a result of the circuit being in a test and debug mode. When the comparator is enabled and the signals ROM register 32 and unit 31 are the same, a signal is sent to switch 34. Switch 34 has the TDO signal from the core processor 11 applied to the input terminal. When a signal from the comparator 33 is applied to the switch, the switch is opened and the TDO signal is prevented from being transmitted through the switch 34. In this manner, protected areas in the memory are prevented from being applied to the emulation unit and, subsequently to the host processing unit. The TDO signal will also be transmitted when the unlock signal is present.

### 2. OPERATION OF THE PREFERRED EMBODIMENT

The present invention can be understood in the following manner. The address (es) of the protected data are stored in the memory security module. When the memory units 14, 15, and 16 are accessed at addresses determined by addresses stored in the protected memory address unit 315, the contents of those memory addresses in the form of TDO signals will be prevented from being transmitted to the JTAG emulation unit. Thus, protection is supplied to the data retrieved from the addresses that are stored in the protected address memory unit.

In certain processor cores, such as selected processing cores from the ARM corporation, the JTAG signals can not be directly applied to the processing core. For these processing cores, an interface unit can be provided that permits the JTAG test and debug signals to be exchanged with the processing core. This interface unit is herein referred to as the test access port (TAP) unit.

The addresses in the protected memory address unit can be stored in the processing unit during fabrication or a mechanism can be provided that permits a user to determine or change the protected addresses.

The protected data can also be released by using a user-generated unlock signal. This signal permits the switch to remain closed thereby permitting all of the normally protected data in the memory units to be transmitted to the JTAG emulation unit. As will be clear, with additional apparatus selected portions of the protected data can be transmitted to the JTAG emulation unit.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. Apparatus for protecting selected memory addresses in memory units of a processing unit from being processed by a test and debug procedure, the apparatus comprising:
an emulation unit responsive external control signals, the emulation unit generating input test and debug signals, the processing unit generating output test and debug signals;
a memory unit: and
a memory security system, the memory security system including:
a storage unit including the addresses of protected signals stored in the memory unit;
an input register coupled to the memory unit for storing the address of signals stored in the memory unit and accessed by the test and debug procedure;
a comparator for comparing the addresses in the storage unit with the address in the input register, a positive comparison resulting in a first signal; and
a switch having the output test signals applied to an input terminal, the input signal being coupled to the output terminal of the switch in the absence of the first signal.

2. The apparatus as recited in claim 1 wherein an unlock signal applied to the switch will couple input terminal of the switch to the output terminal.

3. The apparatus as recited in claim 1 wherein the memory unit is selected from a group consisting of a RAM memory unit, a ROM memory unit, and a Flash memory unit.

4. The apparatus as recited in claim 1 wherein the test and debug procedure is a JTAG test and debug procedure.

5. The apparatus as recited in claim 4 wherein the output test and debug signals are JTAG TDO signals.

6. The apparatus as recited in claim 1 wherein the processing unit includes processor core, the apparatus further comprising a test access port, the test access port providing an interface between the emulation unit and the processor core.

7. A method for protecting selected portions of a memory unit associated with a processing unit from retrieval by a test and debug procedure, the method comprising preventing the transmission of output signals resulting from the test and debug procedures to an emulation unit when the output signals are stored in predetermined addresses of the processor memory.

8. The method as recited in claim 7 further comprising comparing the predetermined addresses to the addresses being accessed by the test and debug procedure, wherein a positive comparison during the comparing step prevents the output signals generated by the test and debug procedure from being applied to the emulation unit.

9. The method as recited in claim 7 further comprising transmitting output signals generated by the test and debug procedures when an unlock signal is generated.

10. The method as recited in claim 7 wherein the test and debug procedure is a JTAG test and debug procedure.

11. The method as recited in claim 10 wherein the output signals are the JTAG TDO signals.

12. The method as recited in claim 7 further comprising performing the comparing in a memory security module.

13. A memory security module, the memory security module preventing unauthorized signals stored in a memory unit associated with a processor core from being retrieved from the memory unit by a test and debug procedure, the module comprising:
a storage unit including the addresses of protected stored signals;
an input register for storing the address of signals currently accessed in the memory unit;
a comparator for comparing the addresses in the storage unit with the address in the input register, a positive comparison resulting in a first signal; and
a switch having the output test and debug signals applied to an input terminal, the output test and debug signals being applied to the output terminal of the switch in the absence of the first signal.

14. The module as recited in claim 13 wherein an unlock signal results in the test and debug signal being transmitted by the switch in the presence of the first signal.

15. The module as recited in claim 13 wherein the test and debug procedure is a JTAG test and debug procedure and the output test and debug signals are the TDO signals.

16. The module as recited in claim 13 wherein the memory unit is selected from the group consisting of a RAM memory unit, a ROM memory unit and a Flash memory unit.
